(19) United States
(12) Patent Application Publication
(10) Pub. No.: US 2026/0257532 A1
(43) Pub. Date: Sep. 3, 2026

(54) Thermal Energy System for Controlling Temperatures of a Vehicle and Vehicle Comprising a System of this Type

(71) Applicant: ZF Friedrichshafen AG, Friedrichshafen (DE)

(72) Inventors: Axel Rohm, Schonungen (DE); Tobias Höche, Hallstadt (DE)

(21) Appl. No.: 18/880,059

(22) PCT Filed: Jun. 29, 2023
(86) PCT No.: PCT/EP2023/067839

§ 371 Date: Dec. 30, 2024

(30) Foreign Application Priority Data
Jun. 30, 2022 (DE) 102022206702.9

(51) Int. Cl. B60H 1/00

(52) U.S. Cl. CPC B60H 1/00921; B60H 1/00278; B60H 2001/00307; B60H 2001/00928; B60H 2001/00942

(57) ABSTRACT

A thermal energy system includes a heat pump with a cooling unit for cooling a coolant flow, a heating unit for heating a coolant flow, and a plurality of system sections. A first system section is configured to cool a first vehicle section with a first electronics unit, and a fifth system section is configured to cool a fifth vehicle section with a motor. The system also includes a low-temperature LT conducting path downstream of the cooling unit and a high-temperature HT conducting path downstream of the heating unit. The LT conducting path is configured to conduct the coolant flow to the first system section and to at least one further system section to cool and/or heat another vehicle section having a passenger compartment, a battery, or a radiator. A first one of the HT and LT conducting paths is also configured to conduct the coolant flow to the heating unit, and a second one of the HT and LT conducting paths is also configured to conduct the coolant flow to the cooling unit.

### CROSS-REFERENCE TO RELATED APPLICATIONS

The present application is related and has right of priority to German Patent Application No. DE 102022206702.9 filed on Jun. 30, 2022 and is U.S. National Phase of PCT/EP2023/067839 filed on Jun. 29, 2023, both of which are incorporated by reference in their entireties for all purposes.

### TECHNICAL FIELD

The invention relates generally to a thermal energy system for controlling temperatures of a vehicle and to a vehicle having such a thermal energy system.

### BACKGROUND

Electric vehicles require a cooling system in order to dissipate power losses that arise in the units (battery, electric machine (e-machine, e-motor, eDrive), reduction gear, bearings, etc.) and electronic components (power electronics units such as inverters, DC/DC converters, DC-AC converters, etc.) during operation and during the charging of the battery.

The vehicle systems in this connection usually have multiple cooling circuits, some of which can be coupled to one another in order to form a thermal management system. In general, a coolant circuit having a water-glycol coolant is present, via which the heat is dissipated to the surroundings. A further circuit includes a heat pump/an AC compressor for air conditioning the passenger compartment or for assisting in the dissipation of heat from the components. A third circuit is provided in many systems for dissipating heat from the lube oil- and cooling oil-system of the transmission.

In the known systems, two fundamental principles regarding the interior air conditioning and the cooling of the power electronics prevail.

The passenger compartment is heated by a coolant heat exchanger from the cooling circuit of the electrical propulsion unit and is cooled via the refrigeration circuit of the air conditioning system/of a heat pump, which requires additional heat exchangers for air conditioning the passenger compartment. For greater heat output, additional electrical heaters are usually necessary, which directly heat either the coolant flow or the interior air.

The second principle bundles the functions of heating and cooling via the refrigeration circuit, in that, instead of using a heating heat exchanger, a condenser heat exchanger is used and, as necessary, the air is conducted either through this (heating) or through the evaporator heat exchanger (cooling).

Common to all systems is that the power electronics for cooling are connected in series upstream of the electric machine, wherein the coolant flow, which is then preheated, is used to cool the motor.

The energy store/rechargeable battery/high-voltage (HV) battery also has losses during energy conversion due to the chemical and physical processes within the cells. The effect of the losses depends on power and temperature, such that, at low powers, the power loss is also low and the greater the energy conversion is, the higher are the internal losses. In order to ensure the cooling capacity, most systems include liquid cooling for this purpose.

Electrical propulsion units require an intelligent distribution of energy in order to efficiently utilize the available battery capacity. The known thermal management systems divide the functions of interior air conditioning (heating/cooling) into multiple heat exchangers (water-air for the heating and refrigerant-air for the cooling). Electrical auxiliary heaters are frequently also provided for this purpose.

In addition to the costs, other disadvantages here include the installation space requirement and the line length and the material usage.

Furthermore, the series circuit for cooling of the power electronics and the electric machine results in a deterioration of the performance of the e-machine or the efficiency of the eDrive. Due to a high temperature of the coolant, the current-carrying capacity of the power electronics is reduced, such that the cooling capacity is limited. However, a higher temperature in the eDrive results in reduced mechanical losses due to a lower viscosity of the oil. At a low coolant temperature, this property reverses. A compromise must therefore always be found.

### SUMMARY

Example aspects of the present invention provide a thermal energy system and a vehicle which eliminate one or more of the aforementioned disadvantages. In particular, one problem addressed by example aspects of the present invention is that of providing an efficient thermal energy system and a vehicle having such a thermal energy system, in which the energy loss of the vehicle and/or of individual components is used to the greatest extent possible and only excess, non-usable energy is released to the surroundings.

A first example aspect provides a thermal energy system for controlling temperatures of a vehicle, which thermal energy system includes a heat pump with a cooling unit for cooling a coolant flow and a heating unit for heating a coolant flow, which heat pump is designed such that thermal energy from a coolant flow, which is supplied to the cooling unit, can be supplied to a coolant flow, which is supplied to the heating unit. The thermal energy system has a multitude of system sections and the system sections are designed to heat and/or cool a respective vehicle section of the vehicle. A first system section of the system sections for cooling a first vehicle section of the vehicle sections has at least one first electronics unit, and a fifth system section for cooling a fifth vehicle section of the vehicle sections has a motor. The system also includes a low-temperature LT conducting path beginning downstream of the cooling unit and a high-temperature HT conducting path beginning downstream of the heating unit, wherein at least one of the HT and LT conducting paths is designed to conduct a coolant flow to at least one of the multitude of system sections. Downstream of the cooling unit, the LT conducting path is designed to conduct the coolant flow to the first system section of the multitude of system sections. The LT conducting path is also designed such that, when conducting the coolant flow to the fifth system section downstream of the first system section and upstream of the fifth system section, the coolant flow is conducted to at least one further system section, which further system section is designed to cool and/or heat another vehicle section having a passenger compartment, a battery, or a radiator. A first one of the HT and LT conducting paths is also designed to conduct the coolant flow to the heating unit, and a second one of the HT and LT conducting paths is also designed to conduct the coolant flow to the cooling unit.

Therefore, one of the HT and LT conducting paths can conduct the coolant flow to the fifth system section having the motor. If the LT conducting path conducts the coolant flow to the motor, the LT conducting path conducts the coolant flow downstream of the first system section to at least one further system section of the system sections before the coolant flow is conducted to the fifth system section. Therefore, further system sections that do not include the first and the fifth system sections can be cooled before the motor is cooled. Improved energy efficiency can therefore be achieved. The further system sections can include or be at least one of a second to fourth system section. Alternatively, if the HT conducting path conducts the coolant flow to the fifth system section, the LT conducting path conducts the coolant flow at least to the first system section.

The system can include the motor, the at least one first electronics unit and/or further electronics units, a passenger compartment heat exchanger of the passenger compartment, a first heat exchanger of the passenger compartment, a second heat exchanger of the passenger compartment, a battery, and/or a radiator. In order to air-condition the passenger compartment, the vehicle and/or the system can provide the passenger compartment heat exchanger. Alternatively, the passenger compartment heat exchanger can be replaced by the two individual heat exchangers. Due to the parallel operation of the first and the second heat exchangers, the passenger compartment air can be dehumidified, in that the air is first conducted over the second heat exchanger and is cooled in the process, wherein the moisture can be condensed and discharged. Thereafter, the air is conducted through the first heat exchanger and re-heated to the target temperature level. It is possible, in principle, however, to cool and heat the passenger compartment using the individual passenger compartment heat exchanger which, in a first operating mode, can be connected to the HT conducting path to heat the air and, in a second operating mode, can be connected to the LT conducting path to cool the air. It is therefore possible to dehumidify the air only during cooling. Due to a suitable device for switching the guidance of the air, thermal energy at one of the first and second heat exchangers, in particular the first heat exchanger, can be emitted either to the passenger compartment or to the ambient air. Due to intermediate positions, a continuously variable distribution of the thermal energy emission between the passenger compartment and the ambient air is possible.

The system sections are designed to heat and/or cool a respective vehicle section. Therefore, each system section is associated with at least one vehicle section. Heating can mean that thermal energy is supplied in order to heat the particular vehicle section or the particular unit. Cooling can mean that thermal energy is removed in order to cool the particular vehicle section or the particular unit. Therefore, a cooling system section can be one of the system sections that cools at least one vehicle section and/or at least one unit of the vehicle section. A heating system section can heat a vehicle section and/or at least one unit of the vehicle section. In particular, the first system section is associated with the first vehicle section. One of the system sections can be designed to exclusively only heat or cool. One of the system sections can be designed to cool and heat. The first conducting path can be designed to heat the first heat exchanger and/or the radiator and to cool the motor.

The conducting paths can be designed to be connectable to the system sections. The system sections can have one or more conducting paths or sections of the LT and/or HT conducting paths.

An electronics unit of the first electronics unit and/or further electronics units (see below) of the vehicle can be an electronic unit that generates thermal energy, in particular during operation, and therefore heats up. In order to ensure that the electronics unit can perform, the electronics unit can be cooled, for example, by the coolant flow of the LT conducting path. The electronics unit can be one of a control electronics, an inverter, a DC/DC converter, a DC/AC converter, and an on-board charger (OBC). Two, three, four or more electronics units can be cooled and/or heated, in particular cooled, by the system according to example aspects of the invention. The first vehicle section can have one, two, three or more first electronics unit(s). Further system sections can have one, two, three or more second and third electronics units. At least one of the first electronics units and the electronics units mentioned in the following can be designed for the open-loop control of a vehicle propulsion unit of the vehicle.

The first of the HT and LT conducting paths is designed to conduct the coolant flow to the heating unit, wherein the second of the HT and LT conducting paths is designed to conduct the coolant flow to the cooling unit (“chiller”). If the first conducting path is the HT conducting path and the second conducting path is the LT conducting path, a system is present that has two coolant flow circuits (dual-circuit configuration). In contrast, if the first conducting path is the LT conducting path and the second conducting path is the HT conducting path, a single coolant flow circuit (single-circuit configuration) is present.

The coolant flow of the LT conducting path can have a temperature that is lower on average than that of the coolant flow of the HT conducting path.

The cooling unit and/or the heating unit can be designed to heat and/or cool the coolant flow that is supplied to the particular unit (on the intake side of the particular unit) and to output this coolant flow to the particular conducting path. At least some of the conducting paths can be formed by tubes, hoses, ducts, and/or a combination thereof.

According to the first example aspect, a thermal energy system is provided, which can always transport the lost energies from the electrical components, in particular from the electronics unit and/or the battery, and the energy from the cooling of the passenger compartment to where this is useful or can be stored in the thermal mass for later use.

Once the demands and the storage capacities have been filled, the energy can be discharged to the surroundings.

In order to increase the efficiency, the heat pump is provided, which heat pump transfers the thermal energy from the coolant flow of the LT conducting path having a low temperature level into the coolant flow of the HT conducting path having a higher temperature level. Due to different flows, it is possible by the heat pump to also use energy from the ambient air for heating purposes. In addition, the heat pump makes it possible to cool/air-condition the passenger compartment.

The basic idea of the system according to example aspects of the invention is based on the implementation of two coolant circuits with the LT conducting path and the HT conducting path having a different temperature level. A difference of the temperatures of the two conducting paths can be between negative ten (−10) K to positive one hundred (+100) K. The thermal coupling of the two coolant flows is established via the heat pump. The heat pump can include a refrigerant reservoir, a compressor, an expansion valve or a throttle valve, an evaporator heat exchanger for the cooling unit and a liquid cooled condenser (LCC) for the heating unit.

In the following, the system will be described having up to three valves (“flow-switch”). These can be arranged such that, due to the particular combination of the switching states of the valves, all necessary operating states of the vehicle can be served using the system. At least one of the valves is advantageously in the form of a radial rotary slide valve, although another design (axial piston valve) is also possible.

The cooling of the motor, which can be in particular an electric motor (e-motor), and the cooling of a motor heat exchanger, in particular of an oil-water heat exchanger (see below) of the motor, can be associated with the HT conducting path, while electronic components such as, in particular, the first electronics units (see below), are integrated in the LT conducting path. The first to third electronics units can include an on-board charger (OBC), a controller, and/or one or more power electronics unit(s) of a vehicle. The first to third electronics units, in particular the first electronics units, can include the OBC and the controller. The separation of the motor and the first electronics units offers the advantage that the first electronics units can be cooled using a lower inlet temperature, and thus greater power and efficiency are achievable, while the motor itself endures fundamentally higher temperature levels and, due to its high thermal mass, can be loaded for a substantially longer time until a limit temperature of the motor has been reached. Therefore, the necessary cooling capacity can be ensured according to demand and in a performance-optimized manner.

The first to third (see below) electronics unit can include electronics subsystems. Furthermore, the first, the second, and/or the third electronics unit(s) can include one single electronics unit or two, three, or more electronics units. The first electronics units can include, in particular, two or three electronics units. The second and/or the third electronics unit(s) can include, in particular, one single electronics unit. At least one of the first through third electronics units can be passed through in series by one of the conducting paths, in particular by the coolant flow of the LT conducting path, wherein, advantageously, the order can be determined on the basis of requirements and/or cooling capacity demands of the electronics units to be passed through. In the order that appears particularly advantageous, the electronics units are first supplied with the coldest coolant flow and the coolant flow then flows through a central computer of the electronics units, while the flow passes through the OBC (on-board charger) at the end, since the OBC is active only when the other systems are switched off or do not generate any substantial power loss/there is no need for cooling capacity. A deviating order of supply is possible and can be determined on the basis of the cooling capacity demands of the various electronics units.

In a further example variant, a parallel supply of the electronics units or a combination of a serial through-flow and a parallel through-flow is possible, in principle. The arrangement can be divided on the basis of the cooling capacity demands and/or mass flow ratios of the electronics units. It is recommended to hydraulically balance the volumetric flows according to the expected cooling capacity ratios with regard to the pressure ratios of the electronics units, in particular of the subsystems, for example, by restrictors at the inlet.

A further feature of the system is the indirect air conditioning of the cabin/passenger compartment, which is achieved using the sole passenger compartment heat exchanger or the two heat exchangers, wherein in particular the passenger compartment heat exchanger is supplied as necessary either with the warm coolant flow from the HT conducting path (heating demand) or the cold coolant flow from the LT conducting path (cooling demand). When there are two separate passenger compartment heat exchangers, the first heat exchanger can be supplied with cold coolant for cooling the passenger compartment air from the LT conducting path, while the second heat exchanger is supplied with the warm coolant flow in order to heat the passenger compartment air. The air that is to be supplied to the passenger compartment can be initially conducted through the first heat exchanger in order to cool the air and, due to the condensation of the air humidity, to enable dehumidification of the air in the passenger compartment. Thereafter, the air can be re-heated to the desired extent by the two heat exchangers.

The system or the vehicle can also have the, in particular only, radiator (see below) for exchanging energy with the ambient air, which radiator can be integrated in the NT-conducting path or the LT conducting path as necessary, thereby making it possible to dissipate the excess power loss, but also to absorb thermal energy from the surroundings in order to supply this thermal energy via heat pump to one of the conducting paths, in particular to the HT conducting path.

The energy store/the battery can also be served according to demand using the two conducting paths, wherein the interconnections allow for a serial supply of the passenger compartment and the battery, as well as the parallel operation thereof. It is therefore possible to cool the passenger compartment regardless of the demand (cooling or heating) of the battery.

The combination of the valves can, in addition, permit an interconnection of the circuits as a hydraulic series circuit of all system sections and/or vehicle sections, such that the vehicle can be operated without operating the heat pump and thus the greatest possible efficiency of the overall system is made possible.

In a second operating mode of this aforementioned series circuit, by the heat pump, the coolant temperature can be lowered prior to the through-flow of the first electronic units and the passenger compartment or the battery and, at the same time, the coolant temperature upstream of the radiator can be raised in order to increase the cooling capacity of the overall system and the air-conditioning performance of the passenger compartment.

Depending on the constraints (temperature, surroundings, driving mode of the vehicle, operating conditions of the vehicle, sun exposure, etc.), different interconnections are necessary in order to meet the requirements for air conditioning and controlling the temperature of the vehicle sections, such as of the first through third, in particular the first, electronics units. The objective of achieving the best possible efficiency in each case can therefore be ensured.

A second system section of the multitude of system sections can be designed to heat and cool a second vehicle section of the vehicle sections having the passenger compartment of the vehicle, in particular a passenger compartment heat exchanger of the passenger compartment of the vehicle. A third system section of the multitude of system sections can be designed to heat and/or cool a third vehicle section of the vehicle sections having the battery of the vehicle. A fourth system section of the multitude of system sections can be designed to heat and/or cool a fourth vehicle section of the vehicle sections having the radiator.

A fifth system section of the multitude of system sections is designed to cool a fifth vehicle section of the vehicle sections having the motor and can be designed in particular to cool at least one second electronics unit and, downstream of the second electronics unit, to cool the motor. The cooling of the second electronics unit and of the motor can be advantageous in particular when, for example, condensation on the second electronics unit is to be prevented. The motor can be arranged in the fifth vehicle section, the first vehicle section, or the third vehicle section, according to a vehicle model of the vehicle.

The first system section can also be designed to cool the first vehicle section having the first electronics unit and the motor such that the particular conducting path conducts the coolant flow downstream of the first electronics unit to the motor and/or parallel to the first electronics unit. In particular, this can be the LT conducting path. It can be advantageous when the electronics unit and the motor are positioned very close to one another or the electronics unit and the motor are integrated in a housing. In this case, it is advantageous to associate the electronics unit and the motor with the LT conducting path and to provide the lowest inlet temperature to the electronics unit first and, thereafter, to conduct the coolant flow directly to the motor. It is possible to integrate additional electronics units in parallel with the first electronics unit (for example, the DC-DC converter), or in series with the motor, if the spatial arrangement is correspondingly advantageous.

The third system section can also be designed to heat and/or cool the third vehicle section having the battery and the motor such that the particular conducting path conducts the coolant flow downstream of the motor to the battery, in particular to a third electronics unit, downstream of the third electronics unit to the motor and downstream of the motor to the battery. The integration of the third electronics unit and of the motor is advantageous when, for example, the motor must be/is to be installed remote from the heat pump.

The LT conducting path can be the first conducting path and the HT conducting path can be the second conducting path, wherein the LT conducting path is designed to conduct the coolant flow in series to the first, the second, the third, and the fifth sections, and the HT conducting path is designed to conduct the coolant flow in series to the second and the fourth system sections. This can correspond to the single-circuit configuration. Due to the configuration according to example aspects of the invention and the arrangement of the components and of the heat exchanger, a thermal bypass is possible, in that, particularly advantageously, the temperature of the coolant flow upstream of the first electronics unit and the second heat exchanger is lowered in order to cool the passenger compartment and thus a higher cooling capacity potential and an air conditioning are made possible at all. The heating unit is arranged such that, subsequent thereto, the coolant flows through the first heat exchanger of the passenger compartment and, thereafter, the radiator before the coolant flow is conducted to the cooling unit. The single-circuit configuration can therefore have a different temperature level, which allows for an increase in the heat output, in that the inlet temperatures at the main components are optimized. The heat pump is thermally integrated such that this enables a thermal bypass in order to bring the coolant flow supply to the first electronics unit to a lower temperature level. This energy is supplied upstream of the first heat exchanger and raises the inlet temperature for the passenger compartment heating and/or the radiator. Therefore, the overall system cooling capacity is increased. Moreover, when the heat pump is inactive, an eco mode is possible, which enables, in particular, an increase in the range of the vehicle.

The HT conducting path can be the first conducting path and the LT conducting path can be the second conducting path, wherein the HT conducting path is designed to conduct the coolant flow to the second, the fourth, and the fifth system sections in series, and the LT conducting path is designed to conduct the coolant flow to the first, the second, and the third system sections in series. The simplified configuration is particularly advantageous, which not only requires fewer components, but also substantially less outlay for a control unit or control electronics of the system, such that significant advantages with respect to installation space and costs are achieved here.

Both of the aforementioned configurations can be, in particular, advantageous when the system has no valves.

At least one of the first through fifth system sections can have one, two, or more system conducting path(s), wherein the system conducting paths are designed to be connectable to at least one of the LT and HT conducting paths by one, two, or more inlet(s) and/or outlet(s) of the system conducting paths. Therefore, a coolant flow from one of the conducting paths can be conducted further by a system conducting path. Alternatively or additionally, at least one of the first through fifth system sections can include sections of the LT and/or HT conducting paths. At least one of the first through fifth system sections can be designed to cool and/or heat the particular vehicle section by the system conducting paths and/or the sections.

The system can include a first and a second valve, each of which has first and second switching states, each valve having two valve inlets and two valve outlets for connecting to the HT and LT conducting paths. Therefore, the valves can be junction points at which the LT and HT conducting paths are connected to the particular junction point. The first valve has two inlets, wherein a first inlet is provided for the LT conducting path and a second inlet is provided for the HT conducting path. In addition, the first valve has two outlets, specifically one outlet for the HT conducting path and one outlet for the LT conducting path. The above-described configuration can apply to the second valve and to every further valve. The HT and LT conducting paths can be designed to conduct the coolant flows, on the basis of the switching states of the first and the second valves, to at least one of the multitude of system sections.

The first valve can be designed to conduct the coolant flow, on the basis of the first switching state a) of the first valve, from the fourth system section to the fifth system section or the heating unit, and to conduct the coolant flow from the third system section to the cooling unit. In addition, the first valve can be designed to conduct the coolant flow, on the basis of the second switching state b) of the first valve, from the third system section to the fifth system section or directly to the heating unit, and to conduct the coolant flow from the fourth system section to the cooling unit. The first valve can have the aforementioned switching states regardless of whether a cooling and/or heating of the passenger compartment is carried out by the passenger compartment heat exchanger or the first and the second heat exchangers.

The second system section can include a heating section and a cooling section, wherein the heating section is designed to heat the first heat exchanger of the passenger compartment heat exchanger and the cooling section is designed to cool the second heat exchanger of the passenger compartment heat exchanger, wherein the cooling section is arranged downstream of the first system section and upstream of the third or the fourth system section, and the heating section is arranged downstream of the heating unit and upstream of the fourth or the third system section. The aforementioned configuration of the second system section can be advantageous, in particular, when, instead of the individual passenger compartment heat exchangers, the first and the second heat exchangers are present.

The second valve can be designed to conduct the coolant flow, on the basis of the first switching state c) of the first valve, from the cooling section to the third system section and to conduct the coolant flow from the heating section to the fourth system section, wherein the second valve can also be designed to conduct the coolant flow, on the basis of the second switching state d) of the second valve, from the cooling section to the fourth system section and to conduct the coolant flow from the heating section to the third system section. Correspondingly, when the first and the second heat exchangers are present, all necessary operating states of the vehicle can be achieved by the first and the second valves. By the configuration according to example aspects of the invention and two heat exchangers, the interior air of the passenger compartment can be dehumidified, since, for this purpose, the air is initially cooled in order to condense the moisture and is then re-heated. This is not possible under all ambient conditions using only one single passenger compartment heat exchanger. In order to ensure the dehumidification function, it can be advantageous to heat and cool the passenger compartment using the first and the second heat exchangers in each case. According to the dual-circuit configuration, the first and the second heat exchangers can be used to cool and heat the passenger compartment. The switching states of the first and the second valves enable the cooling of all components and optionally the cooling or heating of the battery regardless of the air conditioning of the passenger compartment, similarly to the basic layout.

The system can also include a third valve having a first and a second switching state, which third valve has two valve inlets and two valve outlets for connecting to the HT and LT conducting paths, wherein the HT and LT conducting paths are designed to conduct the coolant flows, on the basis of the switching states of the first through third valves, to at least one of the multitude of system sections. Providing the third valve in addition to the first and the second valves can be advantageous, in particular, for the configuration having the individual passenger compartment heat exchanger.

The second and the third valves can be designed, on the basis of:
the first switching states c), e) of the second and third valves, to conduct the coolant flow from the first system section to the second system section, to conduct the coolant flow from the second system section to the third system section, and to conduct the coolant flow from the heating unit to the fourth system section; and/or
the first switching state c) of the second valve and the second switching state f) of the third valve, to conduct the coolant flow from the first system section to the second system section, to conduct the coolant flow from the second system section to the fourth system section, and to conduct the coolant flow from the heating unit to the third system section;
the second switching state d) of the second valve and the first switching state e) of the third valve, to conduct the coolant flow from the first system section to the fourth system section, to conduct the coolant flow from the heating unit to the second system section, and to conduct the coolant flow from the second system section to the third system section; and/or
the second switching states d) and f) of the second and third valves, to conduct the coolant flow from the first system section to the third system section, to conduct the coolant flow from the heating unit to the second system section, and to conduct the coolant flow from the second system section to the fourth system section.

The thermal energy system can be designed to heat and/or cool, on the basis of the switching states of at least one of the first through third valves, the second, the third, the fourth, and/or the fifth system section(s) by the HT and LT conducting paths. The heating and/or cooling can also be improved by the radiator, in that, by the radiator, thermal energy can be released to the ambient fluid or thermal energy can be absorbed from the ambient fluid. Correspondingly, excess thermal energy can be released to the ambient fluid or thermal energy from the ambient fluid can be supplied to the coolant flows.

The system can also include a first and/or a second coolant pump, wherein the first coolant pump can be arranged along the first conducting path upstream of the heating unit or upstream of the fifth system section and designed to pump the coolant flow to the heating unit. The second coolant pump can be arranged along the second conducting path upstream of the cooling unit and designed to pump the coolant flow to the cooling unit. The system can include further coolant pumps.

The first and/or the second coolant pump(s) can have an active state and an inactive state, wherein the first and/or the second coolant pump(s) in the active state are designed to pump the coolant flow, wherein the first and/or the second coolant pump(s) in the inactive state are designed to further conduct the coolant flow without pumping.

The coolant flow of the HT conducting path can have a higher temperature when exiting the heating unit than that of the coolant flow of the LT conducting path when exiting the cooling unit.

The heat pump can have an active state and an inactive state, wherein the heat pump can be designed such that, in the active state, the heat pump supplies thermal energy from the coolant flow, which is supplied to the cooling unit, to the coolant flow, which is supplied to the heating unit, wherein the heat pump can be designed such that, in the inactive state, the heat pump prevents an exchange of thermal energy between the cooling unit and the heating unit. Therefore, the heat pump in the inactive state can further conduct the coolant flow supplied to the particular cooling unit or heating unit without thermal energy being supplied or removed.

The fifth system section can be designed to cool a motor heat exchanger, in particular an oil-water heat exchanger for cooling the motor. Alternatively, the motor can be cooled using water cooling.

The motor heat exchanger can have an active state and an inactive state, wherein the motor heat exchanger in the active state is designed to exchange thermal energy with the motor, wherein, when the motor heat exchanger is in the inactive state, an exchange of thermal energy with the coolant flow of the particular conducting path does not take place or is prevented.

The HT and/or the LT conducting path(s) can have an active state and an inactive state, wherein, in the active state of the conducting path(s), thermal energy is transported by the coolant flow, wherein the conducting path(s) is/are designed such that, in the inactive state of the conducting path(s), the transport of thermal energy is prevented. In the inactive state, the coolant flows of the conducting paths can be conducted, in particular circulated, although thermal energy is not transported.

The first, the second, and/or the third valve(s) can be designed to switch the switching state combinations:
a, c, f;
a, d, e; and/or
b, d, f;
   Each of the first through third valves can be designed to switch between the two particular switching states. If only the first and the second valves are provided, the first and the second valves are designed to switch the switching state combinations a and c, a and d, or b and d. In addition, the first and the second valves or the first through third valves can be designed to switch any possible switching state combinations of a, b, c, d, e, and f.

The radiator can have an active operating state and an inactive operating state. In the active operating state, the radiator can be designed to cool or heat the ambient fluid, in particular the ambient air of the vehicle, wherein, in the inactive operating state of the radiator, an exchange of thermal energy with the ambient fluid and/or the radiator cannot take place or is prevented. The radiator can be designed to supply thermal energy of the coolant flow, which is supplied to the radiator, to the ambient fluid or from the ambient fluid to the coolant flow. The fourth system section can have a parallel circuit with a bypass valve. The parallel circuit can include a first conducting path section and a second parallel conducting path section. The first parallel conducting path section can be designed to conduct the coolant flow downstream of the bypass valve to the radiator. The second parallel conducting path section can be designed to conduct the coolant flow in parallel to the first parallel conducting path section, in particular such that the coolant flow is conducted past the radiator. On the basis of a switching of the bypass valve, the coolant flow can be conducted to the radiator or in parallel past the radiator.

The system can also include a first and/or a second expansion reservoir. The first and/or the second expansion reservoir(s) can be designed to supply coolant to one of the coolant flows or to receive coolant therefrom. The first expansion reservoir can be designed to supply coolant to the coolant flow of the first conducting path or to receive coolant therefrom. The second expansion reservoir can be designed to supply coolant to the coolant flow of the second conducting path or to receive coolant therefrom. In the dual-circuit configuration, the first and the second coolant reservoirs can be provided. This can be advantageous, in particular, in the configuration without valves with the dual circuit. If the single-circuit configuration is present and/or a switch can be carried out between the single-circuit configuration and the dual-circuit configuration by the two or three valves, a single one of the first and the second expansion reservoirs can be provided. In the single-circuit configuration, coolant can be supplied from a single one of the expansion reservoirs to the entire coolant circuit. If a switch is carried out to the dual-circuit configuration at a later point in time, coolant can be correspondingly supplied or received in advance in the single-circuit configuration.

The coolant reservoir and the first and/or the second expansion reservoir(s) can be designed to compensate for changes in pressure and/or changes in volume of the coolant due to temperature differences.

The system can be designed to heat and/or cool the passenger compartment, in particular the passenger compartment heat exchanger, or the first and the second heat exchangers by the second system section, to heat and/or cool the battery by the third system section, to heat and/or cool the radiator by the fourth system section, and/or to cool the motor by the fifth system section. The system can also be designed to achieve the heating and/or cooling of the system sections on the basis of the switching states of the first and the second valves or of the first through third valves. In addition, the system can be designed to switch the first and the second valves or the first through third valves between the first and the second switching states in order to enable the heating and/or cooling of the system sections.

The system can be designed to enable a volume compensation and/or a pressure compensation between the coolant flows of the HT and LT conducting paths. For this purpose, the system can include a compensating line, which is connected to the particular coolant flows and/or conducting paths. This is advantageous, in particular, in the dual-circuit configuration. In addition, this compensation can be carried out by a single reservoir, for example the first or the second expansion reservoir. The compensating function can be made available with a line cross-sectional area that can be, in particular, relatively small. Alternatively, the compensating line can have a throttle valve. Both alternatives can be designed such that filling with coolant is enabled. The compensating line can be connected to the conducting paths such that a first end of the compensating line having coolant is arranged upstream of the first coolant pump and a second end of the compensating line is arranged upstream of the second coolant pump in order to supply or remove coolant there, in each case. These positions are advantageous, since the pressure of the coolant flows is relatively unaffected here by pressure resistances of the HT and LT conducting paths.

A second example aspect provides a vehicle, in particular an electronic vehicle having a thermal energy system according to the first example aspect.

Above-described features of the first example aspect can be designed as features of the second example aspect.

### BRIEF DESCRIPTION OF THE DRAWINGS

Preferred exemplary embodiments are explained by way of example on the basis of the accompanying figures, wherein:

FIGS. 1 and 2 show a schematic view of a thermal energy system according to a first exemplary embodiment;

FIG. 3 shows a schematic view of a thermal energy system according to a second exemplary embodiment;

FIGS. 4 to 8 show a schematic view of a thermal energy system according to a third exemplary embodiment;

FIG. 9 shows a schematic view of a thermal energy system according to a fourth exemplary embodiment;

FIG. 10 shows a schematic view of a thermal energy system according to a fifth exemplary embodiment;

FIG. 11 shows a schematic view of a thermal energy system according to a sixth exemplary embodiment;

FIG. 12 shows a schematic view of a thermal energy system according to an eighth exemplary embodiment;

FIG. 13 shows a schematic view of a thermal energy system according to a ninth exemplary embodiment;

FIG. 14 shows a schematic view of a thermal energy system according to a tenth exemplary embodiment;

FIG. 15 shows a schematic view of a connection between first electronics units and the LT conducting path;

FIGS. 16 to 21 show a schematic view of a thermal energy system according to a tenth exemplary embodiment; and

FIG. 22 shows a schematic view of a vehicle having a thermal energy system.

In the figures, identical or essentially functionally identical or functionally similar elements are labeled using identical reference characters.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

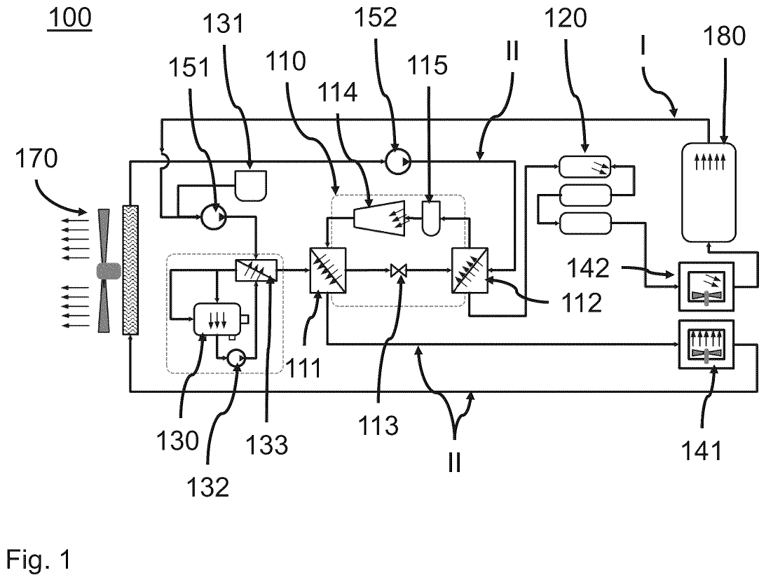

FIG. 1 shows a thermal energy system 100 for controlling temperatures of a vehicle, in particular of an electrically propelled vehicle having a battery 180. The thermal energy system 100 includes a heat pump 110 having a heating unit 111 and a cooling unit 112. The heating unit 111 is designed to supply thermal energy to a coolant flow supplied to the heating unit 111 and thus to heat the coolant flow. The cooling unit 112 is designed to remove thermal energy from a coolant flow supplied to the cooling unit 112 and thus to cool the coolant flow. The thermal energy received by the cooling unit 112 can be transmitted by the heat pump 110 to the heating unit 111 and transmitted to the coolant flow of the heating unit 111. The heat pump 110 also has, according to FIG. 1, an expansion valve 113, a compressor 114, and a reservoir 115 in order to transmit thermal energy from the cooling unit 112 to the heating unit 111.

Downstream of the heating unit 111, a high-temperature HT conducting path begins, which HT conducting path is designed to conduct the coolant flow which is output from the heating unit 111. Downstream of the cooling unit 112, a low-temperature LT conducting path begins, which LT conducting path is designed to conduct the coolant flow which is output from the cooling unit 112. The coolant flow of the HT conducting path can have a higher temperature when exiting the heating unit 111 than that of the coolant flow of the LT conducting path when exiting the cooling unit 112.

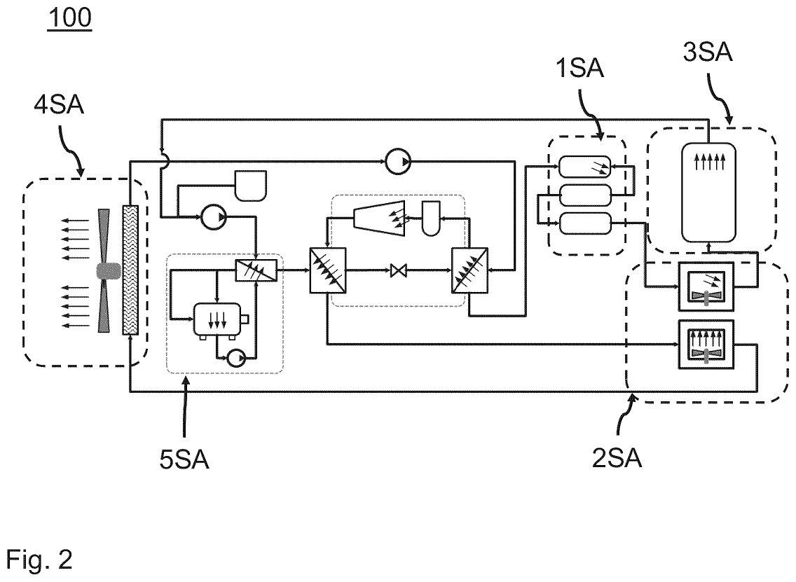

The thermal energy system 100 can have, according to FIG. 2, a multitude of system sections SA. According to FIG. 2, the system 100 has first through fifth system sections 1SA to 5SA. The reference characters of the further units shown were omitted in FIG. 2 for improved clarity. The reference characters of the individual units are shown in FIG. 1. The system sections 1SA to 5SA are designed to heat and/or cool a respective vehicle section of the vehicle.

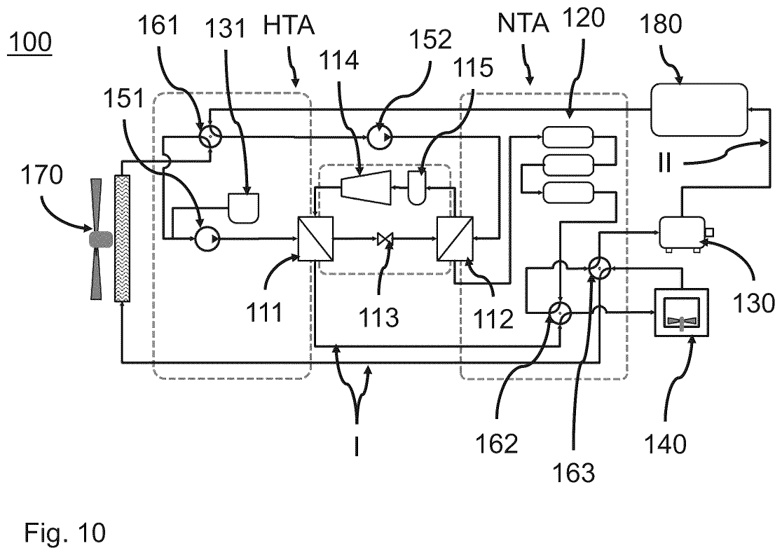

According to FIGS. 1 and 2, the first system section 1SA is designed to cool a first vehicle section having first electronics units 120 of the vehicle, which first electronics units 120 have three electronics units. The first electronics units 120 are arranged in series and the coolant flow of the LT conducting path flows through these one after the other. Particularly advantageously, the coolant can flow through the first electronics units 120 in the following order: power electronics, on-board charger, and control electronics and/or other electronic components, the temperature of which is to be controlled. The second system section 2SA is designed to cool and/or heat a second vehicle section having a passenger compartment heat exchanger 140, in particular to heat a first heat exchanger 141 and to cool a second heat exchanger 142. The first and the second heat exchangers 141, 142 can replace the individual passenger compartment heat exchanger 140. The passenger compartment heat exchanger 140 and the first and the second heat exchangers 141, 142 are designed to heat and cool the passenger compartment of the vehicle. The third system section 3SA is designed to heat and/or cool a third vehicle section having a battery 180 of the vehicle and can be designed to cool and/or heat, in particular to cool, the battery 180. According to FIG. 1, the third system section 3SA cools the battery. The fourth system section 4SA is designed to cool and/or heat a fourth vehicle section having a radiator 170 of the vehicle. By the radiator 170, thermal energy can be exchanged with an ambient fluid, in particular ambient air of the vehicle, such that thermal energy is absorbed by a coolant flow, which is supplied to the radiator 170, and emitted to the ambient air, or thermal energy is absorbed from the ambient air and supplied to the coolant flow. Correspondingly, excess thermal energy can be emitted and additional thermal energy can be absorbed from the ambient air. The fifth system section 5SA is designed to cool a fifth vehicle section having a motor 130, in particular an electric motor. The fifth system section 5SA may not be provided depending on the exemplary embodiment, see, for example, FIG. 10, since the motor 130 is cooled and/or heated by another system section.

In FIG. 1, the first through fifth system sections are not shown in order to improve clarity. The motor can have a motor heat exchanger 132, in particular an oil-water heat exchanger, for transmitting thermal energy to the coolant flow of the fifth system section. FIG. 1 also shows an oil circuit with an oil pump for pumping oil from the motor 130 to the motor heat exchanger 132. By the oil circuit, thermal energy can be transmitted from the motor to the motor heat exchanger 132 and the coolant circuit of the fifth system section 5SA.

FIG. 1 also shows a first and a second coolant pump 151, 152. The first coolant pump 151 is arranged upstream of the fifth system section 5SA and the second coolant pump 152 is arranged upstream of the cooling unit 112. The first and second coolant pumps 151, 152 are designed to pump the respective coolant flow.

FIGS. 1 and 2 show the system 100 according to a single-circuit configuration in which the LT conducting path conducts the coolant flow from the cooling unit 112 to the heating unit 111. The HT conducting path conducts the coolant flow from the heating unit 111 to the cooling unit 112. According to this configuration, a hydraulic series circuit of all shown units can be present. By the single-circuit configuration and the heat pump, energy can be transported from one region of the coolant circuit into another region of the same coolant circuit. Due to the aforementioned order of the components and the heat exchanger, a thermal bypass is possible, in that, particularly usefully, the temperature of the coolant flow upstream of the first electronics units 120 and the second heat exchanger 142 is lowered and thus a higher cooling capacity potential and an air conditioning are made possible at all. The heating unit 111 is arranged such that, downstream thereof, the HT conducting path and the coolant flow pass through the first heat exchanger 141 and, further downstream thereof, through the radiator 170 before the coolant flow flows to the cooling unit via the second coolant pump 152. The coolant flow can therefore have different temperature levels, which allows for an increase in the heat output of the cooling unit 112, in that the inlet temperatures at the main components of the vehicle are optimized. The heat pump 110 is thermally integrated such that this allows for a thermal bypass in order to bring the coolant flow supply to the electronics to a lower temperature level. This energy is supplied upstream of the first heat exchanger into the coolant flow of the HT conducting path and raises the inlet temperature for the first heat exchanger 141 and the radiator 170. Therefore, the overall system cooling capacity is increased. Moreover, when the heat pump 120 is switched off or inactive, an eco mode is possible, which, in particular, allows for an increase in the range of the vehicle due to the reduced energy consumption.

A first conducting path I of the HT and LT conducting paths is designed to conduct the coolant flow to the heating unit, while a second conducting path II of the HT and LT conducting paths is designed to conduct the coolant flow to the cooling unit. According to FIGS. 1 and 2, if the first conducting path I is the LT conducting path and the second conducting path II is the HT conducting path, the single-circuit configuration is present. If the first conducting path I is the HT conducting path and the second conducting path II is the LT conducting path, the dual-circuit configuration is present.

Multiple arrows in the figures shown at certain units such as the motor 130, the heating unit 111, the cooling unit 112, the compressor 114, the first and the second heat exchangers 141, 142 indicate an absorption or emission of thermal energy. For example, the multiple arrows shown at the heating unit 111 indicate that thermal energy is emitted to the coolant flow in order to heat the coolant flow. Correspondingly, the multiple arrows shown in FIG. 1 at the heating unit 111 tend to point downward. In contrast, the multiple arrows of the cooling unit 112 tend to point upward, since thermal energy is absorbed in order to cool the coolant flow.

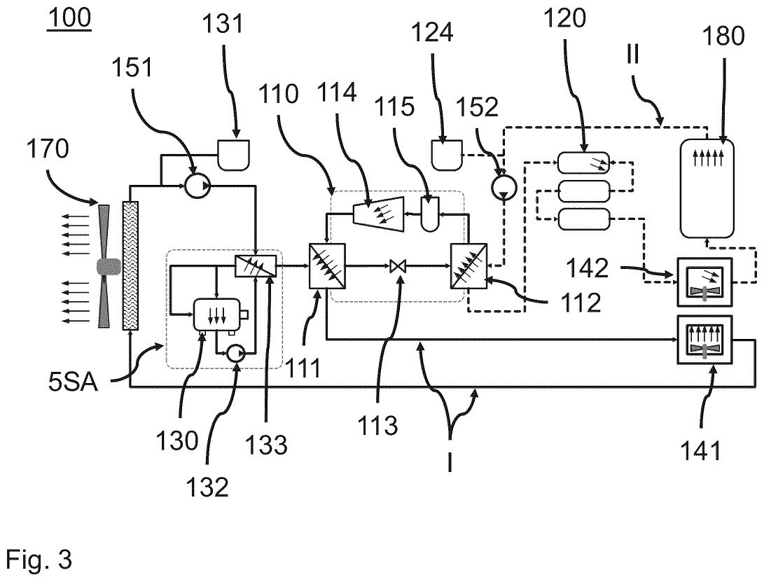

FIG. 3 shows, in comparison to FIGS. 1 and 2, a dual-circuit configuration of the system 100, in which the LT conducting path conducts the coolant flow to the cooling unit 112 and the HT conducting path conducts the coolant flow to the heating unit 111. The HT conducting path conducts the coolant flow to the first heat exchanger 141 for heating the passenger compartment and, thereafter, to the radiator 170, which releases thermal energy from the coolant flow to the ambient air. By the coolant pump 151, the coolant flow is pumped to the motor heat exchanger 132 and, thereafter, conducted to the heating unit 111. The LT conducting path conducts the coolant flow first to the first electronics units 120 in order to cool these. Thereafter, the coolant flow is conducted through the passenger compartment heat exchanger 142, wherein energy can be absorbed from the passenger compartment air and thus the passenger compartment air can be cooled, or this can be prevented. Subsequent thereto, the coolant flow is conducted to the battery 180, which is also cooled. Finally, the coolant flow is pumped to the cooling unit 112 by the coolant pump 152. The thermal energy absorbed from the first electronics units 120, the heat exchanger 142, and the battery 180 by the LT conducting path can be transmitted to the heating unit 111 and thus onto the HT conducting path by the heat pump 110. The simplified configuration is particularly advantageous here, which not only requires fewer components, but also substantially less outlay for a control unit of the system 100, such that significant advantages with respect to installation space and costs are achieved here.

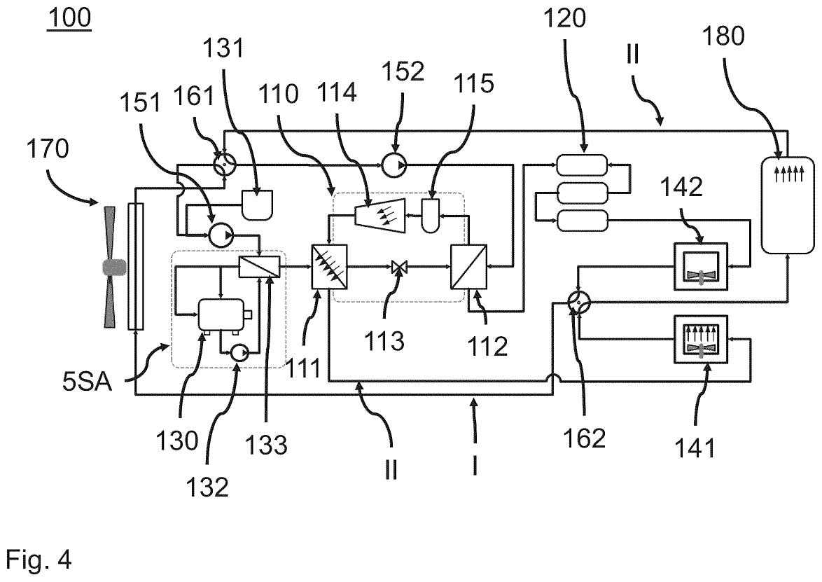

FIGS. 4 to 8 show another exemplary embodiment of the system 100, which has a first and a second valve 161, 162 and the first and the second heat exchangers 141, 142. Each of the valves 161, 162 has two inlets and two outlets and is connected to the HT and LT conducting paths. The first and the second valves 161, 162 each have a first switching state a), c) and a second switching state b), d). The first valve 161 is arranged downstream of the second system section 2SA and of the third system section 3SA and upstream of the cooling unit 112 and of the fifth system section 5SA.

The second system section 2SA can include a heating section and a cooling section, wherein the heating section is designed to heat the first heat exchanger 141 and the cooling section is designed to cool the second heat exchanger 142. The cooling section is arranged downstream of the first system section 1SA and upstream of the third system section 3SA or of the fourth system section 4SA (depending on the switching state of the valves 161, 162, in FIG. 4: upstream of the fourth system section 4SA) and the heating section is arranged downstream of the heating unit 111 and upstream of the fourth system 4SA or of the third system section 3SA (depending on the switching state of the valves 161, 162, in FIG. 4: upstream of the third system section 4SA). The second valve 162 is arranged downstream of the cooling section of the second system section 2SA and downstream of the heating section of the second system section 2SA. In addition, the second valve 162 is arranged upstream of the third system section 3SA and upstream of the fourth system section 4SA.

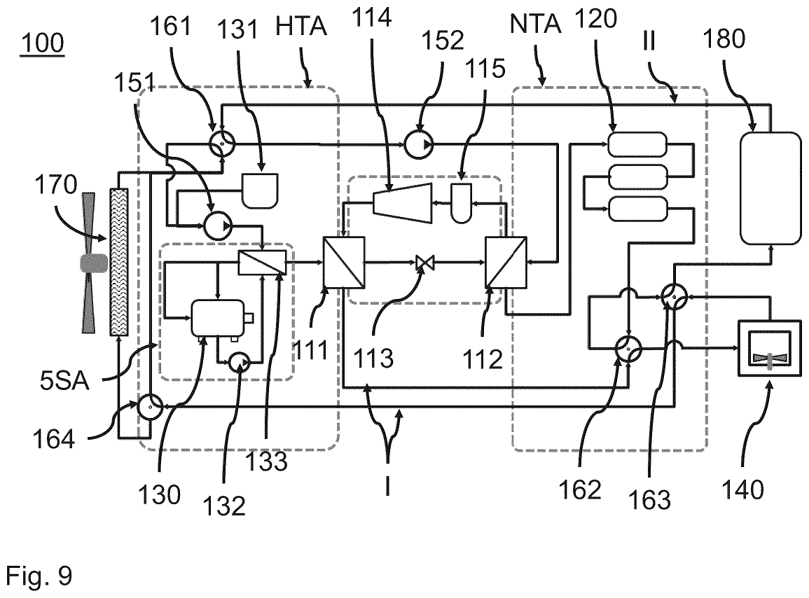

The switching states of the first and the second valves 161, 162 are shown in the following for a better understanding of the figures. These first and second switching states a), c) and b), d) of the first and the second valves 161, 162 also show the first and the second switching states of a third valve 162, see, for example, FIG. 9.

TABLE 1
Switching states of the first through third valves 161, 162, 163

| | First through third |
|---|---|
| | valves 161, 162, 163 |
| Switching state a), c), e) | 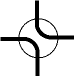 |
| Switching state b), d), f) | 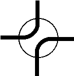 |

According to the switching states of the first through third valves 161 to 163, the various inlets and outlets of the particular valve can be connected as shown in the figures.

According to FIG. 4, the first valve 141 has the first switching state a) and the second valve 162 has the second switching state b). Correspondingly, the LT conducting path conducts the coolant flow from the cooling section of the second system section 2SA to the fourth system section 4SA by the second valve 162 and conducts the coolant flow from the fourth system section 4SA to the fifth system section 5SA by the first valve 161. The HT conducting path conducts the coolant flow from the heating section of the second system section 2SA to the third system section 3SA by the second valve 162 and conducts the coolant flow from the third system section 3SA to the cooling unit 112 by the first valve 161.

According to FIG. 4, the single-circuit configuration is present and the battery 180 is heated. In addition, the motor heat exchanger 133 is in an inactive state and an exchange of thermal energy between the coolant flow of the LT conducting path and the oil circuit is prevented. By switching a unit into the inactive state, electrical energy for operating the unit can be reduced. The passenger compartment is heated by the first heat exchanger 141. The second heat exchanger 142 is inactive or an exchange of thermal energy between the second heat exchanger 142 and the air in the passenger compartment is prevented. In order to prevent the exchange of thermal energy to the surroundings, an advantageous measure according to example aspects of the invention can be to use the air guiding and blocking devices that are often already provided in the vehicle anyway for aerodynamic reasons, for example, to close a shutter in order to block the airflow.

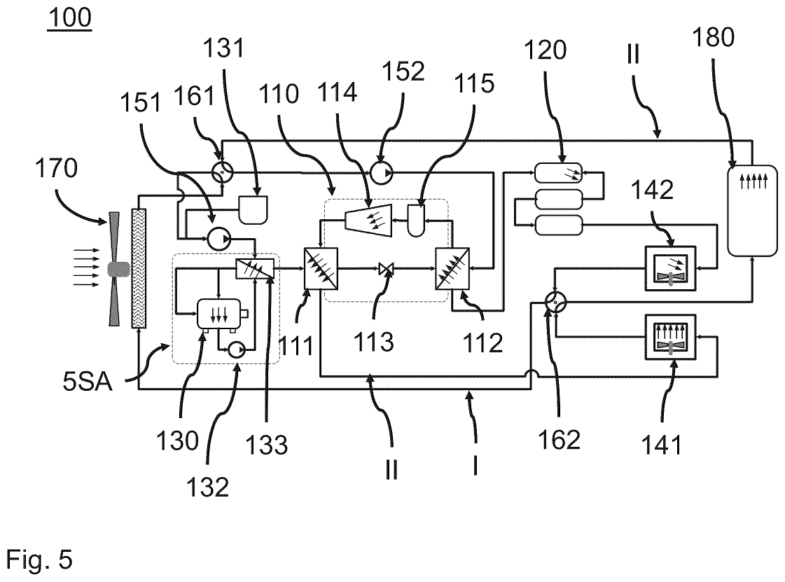

According to FIG. 5, the passenger compartment is cooled by the second heat exchanger 142. In addition, by the radiator 170, thermal energy from the ambient air is supplied to the coolant flow of the LT conducting path.

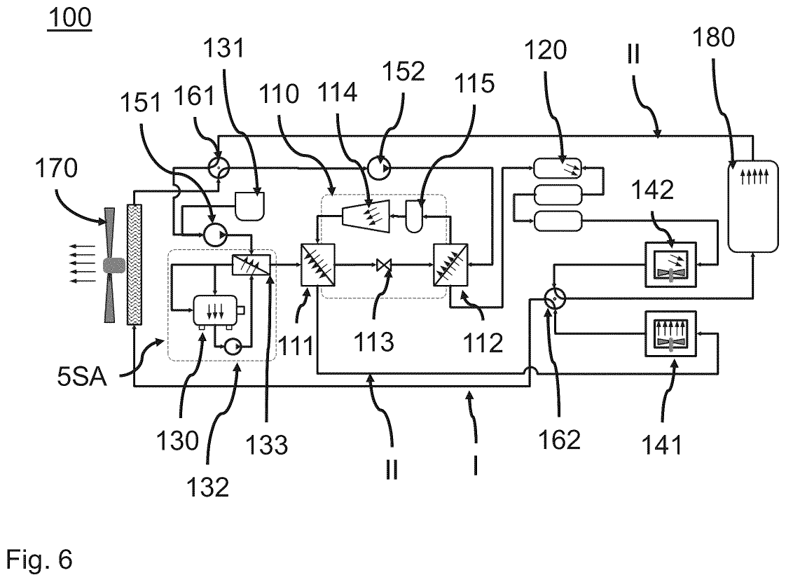

According to FIG. 6, the first valve 161 has the second switching state a) and the second valve 162 has the first switching state c). The LT conducting path conducts the coolant flow from the cooling section of the second system section 2SA having the second heat exchanger 142 by the second valve 162 to the third system section 3SA having the battery 180 and, therefore, the passenger compartment and the battery 180 can be cooled. By the first valve 161, the coolant flow is conducted from the third system section 3SA to the fifth system section having the motor 130 and the motor heat exchanger 132 and, therefore, the motor 130 can be cooled. Thereafter, the coolant flow of the LT conducting path is conducted to the heating unit 111. The first conducting path I is the LT conducting path and the second conducting path II is the HT conducting path.

The HT conducting path conducts the coolant flow by the second valve 162 from the heating section of the second system section 2SA having the first heat exchanger 141 to the fourth system section 4SA. By the first valve 161, the coolant flow of the HT conducting path is conducted from the fourth system section 4SA to the cooling unit 112. The passenger compartment can be heated by the first heat exchanger 141 and, thereafter, the excess thermal energy can be emitted to the ambient air by the radiator 170. The thermal energy absorbed by the LT conducting path from the first electronics units 120, the second heat exchanger 142, the battery 180, and the motor 130 is conducted to the heating unit 111 and, using this thermal energy, the HT conducting path can heat the passenger compartment and, subsequently, the excess thermal energy can be emitted via the radiator 170.

The heat pump 110 can have an active state and an inactive state regardless of the exemplary embodiment shown. In the active state, the heat pump 110 transmits the thermal energy that has been absorbed by the coolant flow supplied to the cooling unit 111 to the heating unit 112. In the inactive state, an exchange of thermal energy between the heating unit 111 and the cooling unit 112 is prevented, in that, for example, the coolant flow of the heat pump 110 between the cooling unit 111 and the heating unit 112 is stopped.

The heat pump 110 can be in the inactive state when the vehicle enters an eco mode. Due to the reduced energy requirement of the heat pump 110 in the inactive state, energy can be conserved.

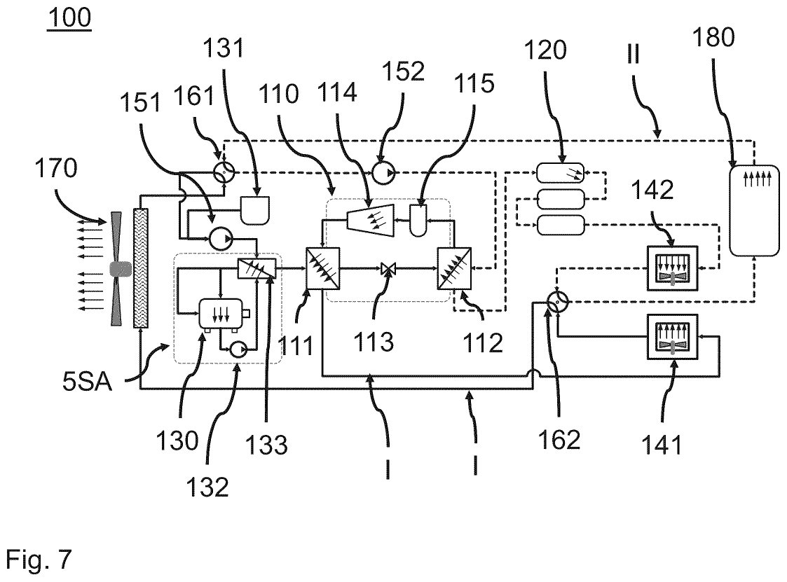

FIG. 7 shows the first valve 161 with the first switching state a) and the second valve 162 with the first switching state c). The LT conducting path conducts the coolant flow downstream of the first system section 1SA to the cooling section of the second system section 2SA and, thereafter, to the third system section 3SA by the second valve 162. By the first valve 162, the LT conducting path conducts the coolant from the third system section to the cooling unit 111. Therefore, if the second conducting path II is the LT conducting path and the first conducting path I is the HT conducting path, the dual-circuit configuration is present.

The HT conducting path conducts the coolant flow to the heating section of the second system section 2SA and, thereafter, by the second valve 162, to the fourth system section 4SA having the radiator 170. By the fourth valve 161, the HT conducting path conducts the coolant flow from the fourth system section 4SA to the fifth system section 5SA having the motor and then to the heating unit 111. According to FIG. 7, a cooling of the passenger compartment and the battery 180 is achieved by the LT conducting path. In addition, a cooling of the motor 130 can be achieved by the HT conducting path, since thermal energy is drawn from the coolant flow by the radiator 170 upstream of the motor 130.

The heat pump 110 can be switched into the active state and into the inactive state in the single-circuit configuration and in the dual-circuit configuration. The eco mode can be applied, in particular, in the single-circuit configuration.

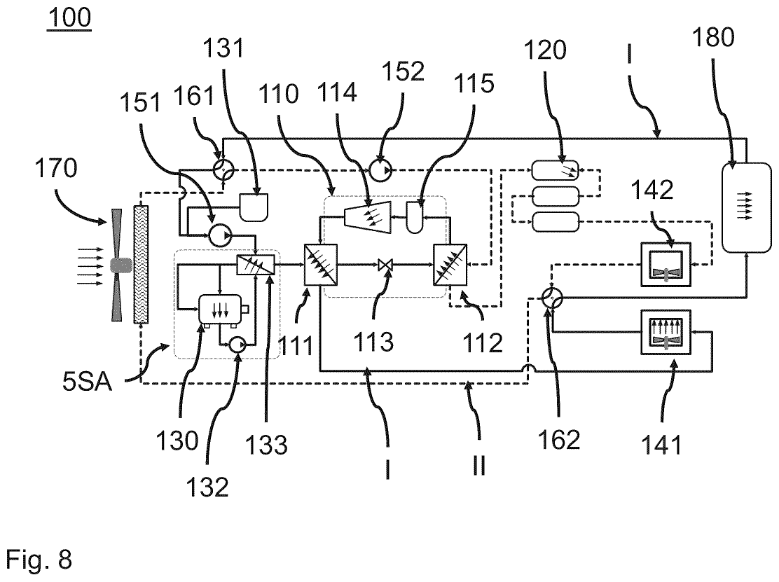

FIG. 8 shows the first valve 161 in the second switching state b) and the second valve 162 in the second switching state d). The LT conducting path conducts the coolant flow by the second valve 162 from the cooling section of the second system section 2SA to the fourth system section 4SA having the radiator 170. Thereafter, the LT conducting path conducts the coolant flow to the cooling unit by the first valve 161. Therefore, the second conducting path II is the LT conducting path and the first conducting path I is the HT conducting path.

The HT conducting path conducts the coolant flow by the second valve 162 from the heating section of the second system section 2SA to the third system section 3SA having the battery 180. Thereafter, the coolant flow is conducted by the first valve 161 to the fifth system section 5SA having the motor and, subsequently, to the heating unit 111. According to FIG. 8, the passenger compartment and the battery 180 are heated and thermal energy is supplied by the radiator 170.

FIG. 9 shows an exemplary embodiment of the system 100 having first through third valves 161, 162, 163. FIG. 9 also shows a bypass valve 164. In comparison to the aforementioned exemplary embodiments, FIG. 9 shows a single passenger compartment heat exchanger 140 instead of the first and the second heat exchangers 141, 142. The first valve 161 has the first switching state a), the second valve 162 has the second switching state d), and the third valve 163 has the second switching state f). The LT conducting path conducts the coolant flow by the second and the third valves 162, 163 from the first system section 1SA having the first electronics units to the third system section 3SA having the battery. Thereafter, the LT conducting path conducts the coolant flow to the cooling unit by the first valve 161. Therefore, if the first conducting path I is the HT conducting path and the second conducting path II is the LT conducting path, the dual-circuit configuration is present. FIG. 9 also shows a high-temperature section HTA and a low-temperature section NTA of the system 100. The high-temperature section HTA and the low-temperature section NTA are regions of the thermal energy system 100, in which a higher temperature of the coolant and a lower temperature of the coolant prevail, respectively. The high- and the low-temperature sections HTA, NTA can include various sections of the HT and LT conducting paths and of the thermal energy system 100.

The HT conducting path conducts the coolant flow from the heating unit 111 by the second valve 162 to the second system section 2SA having the passenger compartment heat exchanger 140. By the third valve 163, the HT conducting path then conducts the coolant flow to the fourth system section 4SA. The fourth system section has, in FIG. 9, the bypass valve 164 as well as a first and a second parallel line. The first parallel line is designed to conduct the coolant to the radiator 170, while the second parallel line conducts the coolant flow past the radiator 170. On the basis of a switching state of the bypass valve 164, the coolant flow of the HT conducting path can be conducted to the radiator 170 or past the radiator. The parallel circuit and the bypass valve 164 are optional. Alternatively, the fourth system section 4SA can conduct the particular coolant flow only to the radiator 170 and does not have a parallel circuit. Due to the bypassing of the radiator 170, first, an exchange of thermal energy with the surroundings can be prevented and, second, the effective/participating thermal mass of the circulating coolant can be reduced, so that, during a heating operation, the response time of the passenger compartment heat exchanger for heating is shortened, in that less energy is required to reach the target temperature. In order to prevent the exchange of thermal energy to the surroundings, advantageous measures according to example aspects of the invention are to arrange the second parallel line on the air side of the radiator 170, since this is often already provided in the vehicle anyway for aerodynamic reasons, for example, to close a shutter in order to block the airflow. In addition, with or without a parallel circuit, a supply of fresh air to the radiator can be blocked or enabled by a shutter of the vehicle. If a supply of fresh air is blocked, nearly exclusively only the thermal mass or capacity of the radiator 170 can be used for the exchange of thermal energy.

FIG. 10 shows another exemplary embodiment of the system 100 having a different arrangement of the motor in comparison to the preceding exemplary embodiments. According to FIG. 10, the third system section 3SA is designed to cool the motor 130. The fifth system section 5SA is not present according to this exemplary embodiment.

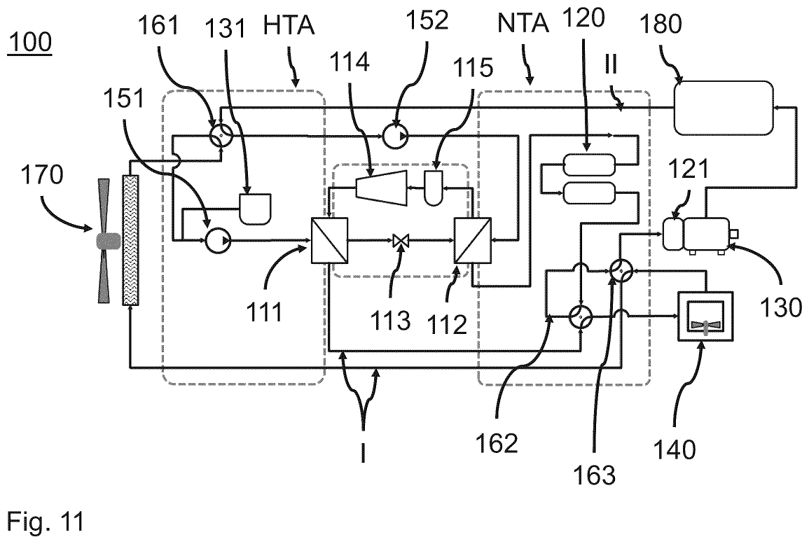

FIG. 11 shows another exemplary embodiment of the system 100, in which the third system section 3SA is designed to cool a second electronics unit 121, the motor 130, and the radiator 180 in series.

The exemplary embodiments shown in FIGS. 10 and 11 are advantageous when the motor 130 must be/is to be installed in the vehicle remote from the heat pump 110. FIGS. 10 and 11 show, only by way of example, one of the reasonably possible integrations of the motor 130 upstream of the battery 180 in each case, wherein, although the motor 130 can be heated, the second electronics unit 121 is inevitably heated when the battery 180 is to be heated, as shown primarily in FIG. 11.

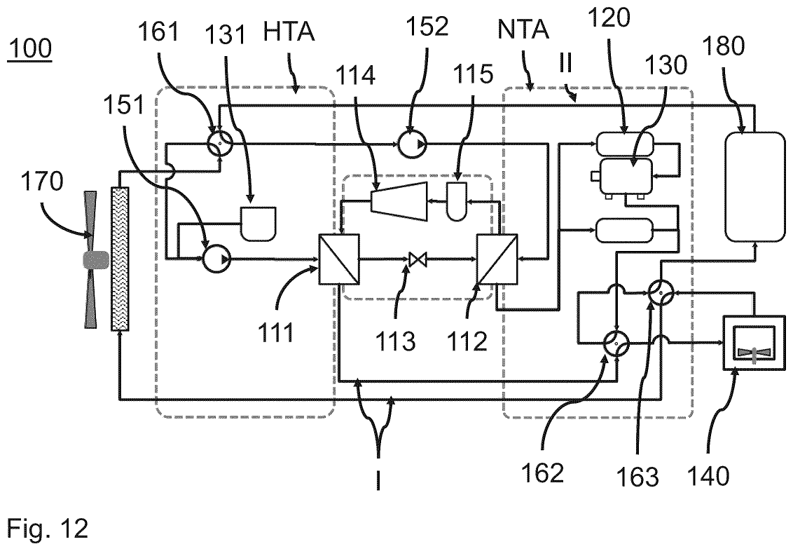

FIG. 12 shows another exemplary embodiment of the thermal energy system 100. As in FIGS. 10 and 11, the first valve 161 has the first switching state a), the second valve 162 has the second switching state d), and the third valve 163 has the second switching state f). According to FIG. 12, the first system section 1SA is designed to cool the motor 130 and the first electronics units 120. According to FIG. 12, the first electronics units 120 and the motor 130 can be positioned close to one another. This can be the case, for example, when the first electronics units 120 and the motor 130 are arranged within a housing. In this case, it is advantageous to associate the first electronics units 120 and the motor 130 with the LT conducting path and to provide the lowest inlet temperature to the first electronics units 120 first and, thereafter, to conduct the coolant directly to the motor for the cooling thereof. It is possible to integrate one of the first electronics units (for example, the DC-DC converter) in parallel, or in series, with the motor 130, if the spatial arrangement is correspondingly advantageous.

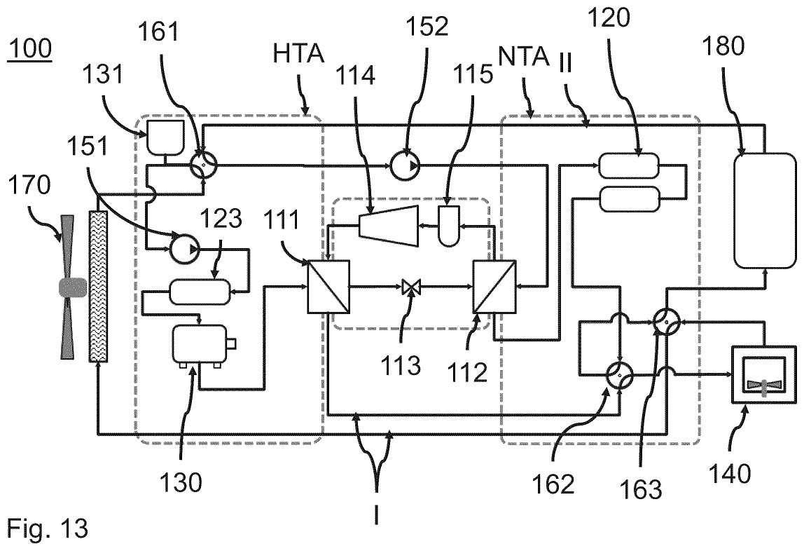

FIG. 13 shows another exemplary embodiment of the system 100, in which the fifth system section 5SA is provided. The fifth system section 5SA is designed to cool a third electronics unit 123 and, downstream thereof, the motor 130. FIG. 13 shows the same switching states of the first through third valves 161, 162, 153 as in FIGS. 10 to 12. Consequently, integrating electronics units into the HT conducting path can also be useful when, for example, condensation on the third electronics unit 123 is to be prevented. In this case, the flow into the third electronics unit should advantageously take place upstream of the heating unit in order to allow for a cooling capacity that is as great as possible.

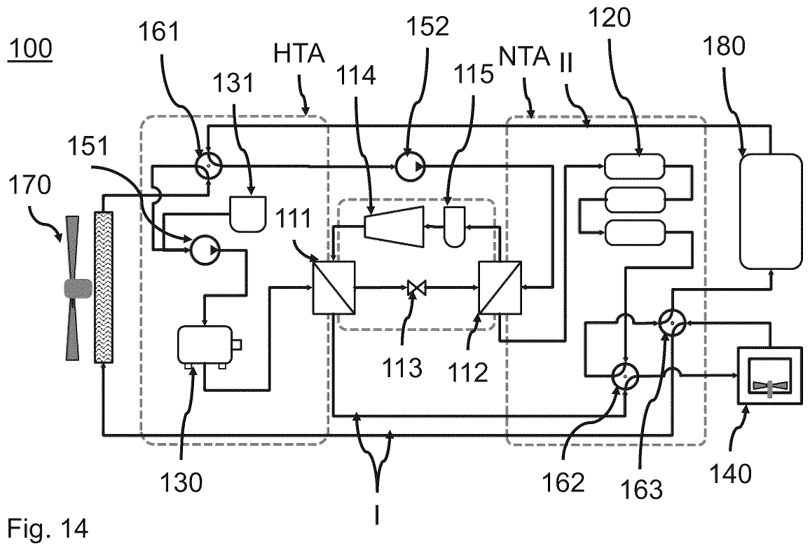

FIG. 14 shows another exemplary embodiment of the system 100 having a water cooling of the motor 130. The first through third valves 161, 162, 163 have the switching states a), b), and f). The first electronics units 120 are cooled in series by the LT conducting path and, thereafter, the battery 170 is cooled. The passenger compartment can be heated by the HT conducting path.

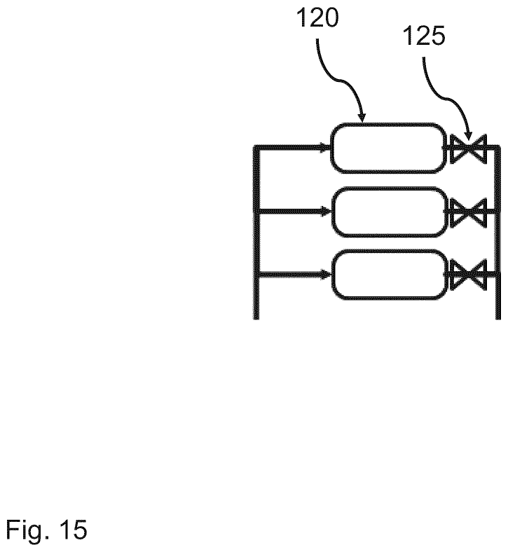

FIG. 15 shows the first electronics unit 120 having chokes 125 downstream of the first electronics units 120. Alternatively, restrictors can be used. The chokes 125 are designed to provide hydraulic balancing. By matching the chokes to the fundamental cooling demands of the individual electronics units, the volumetric flow of each unit 120 can be individually ensured with a constant ratio. The overall supply flow can be divided into individual volumetric flows having a defined ratio. The volumetric flow can be divided, in accordance with the resistances, into the components, such as the electronics units. In order to divide these individual volumetric flows in a certain ratio, hydraulic balancing can be necessary; otherwise the components having the lowest flow resistance would always receive the greater portion regardless of whether this is required or not.

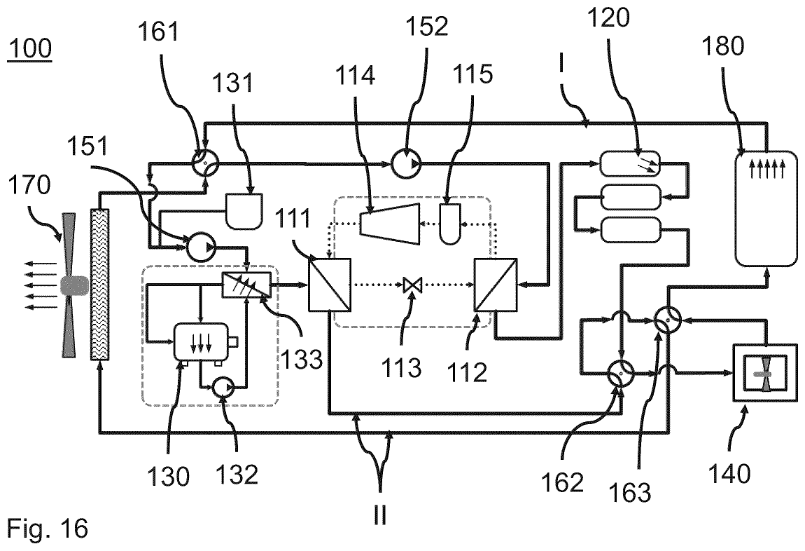

FIGS. 16 to 21 show another exemplary embodiment of the system 100. According to FIG. 16, the first valve 161 has the second switching state b), the second valve 162 has the first switching state c), and the third valve 163 has the first switching state e). The LT conducting path conducts the coolant flow to the first system section 1SA having the first electronics units 120 and, thereafter, by the second valve 162, to the second system section 2SA having the passenger compartment heat exchanger 140, such that at least the first electronics units 120 can be cooled. After the second system section 2SA, the coolant flow of the LT conducting path is conducted by the third valve 163 to the third system section 3SA for cool the battery 180. From the third system section 3SA, the coolant flow of the LT conducting path is conducted by the first valve 161 to the fifth system section 5SA to cool the motor 130 by the motor heat exchanger 133 and then to the heating unit 111. Therefore, the single-circuit configuration is present. The HT conducting path is conducted by the second and the third valves 162, 163 to the fourth system section 4SA to heat the radiator 170 and, subsequently, via the first valve 161 to the cooling unit 112. According to FIG. 16, the heat pump 110 is in the inactive state. In the inactive state, the heating unit 111 and/or the cooling unit 112 can also be inactive, such that the heating unit 111 in the inactive state conducts the coolant flow supplied thereto and a supply of thermal energy is prevented. The cooling unit 112 in the inactive state further conducts the coolant flow supplied thereto, without thermal energy being absorbed from the coolant flow. Due to the inactive state of the heat pump 110, in particular due to the inactive states of the heating unit 111 and of the cooling unit 112, the eco mode can be set.

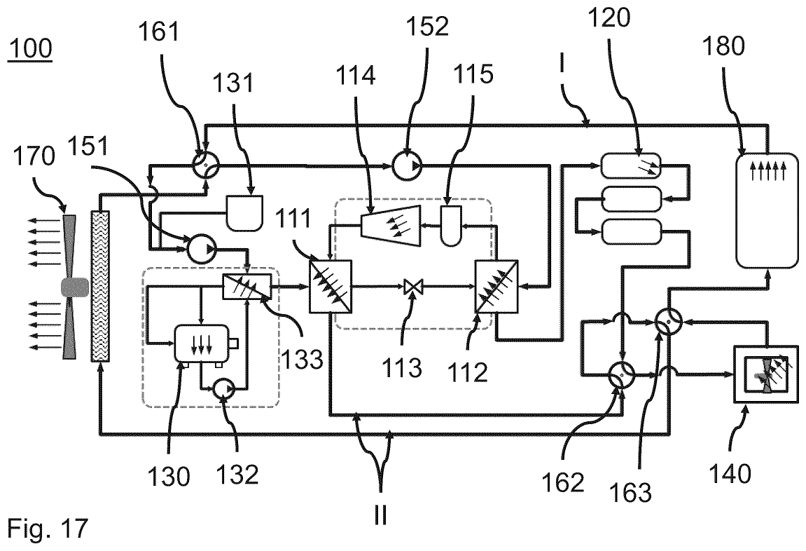

FIG. 17 shows, in comparison to FIG. 16, the heat pump 110 in the active state, in particular in the active state of the heating unit 111 and of the cooling unit 112, and the transmission of thermal energy from the cooling unit 112 to the heating unit 111. The coolant pump 151 pumps the coolant flow of the LT conducting path to the motor heat exchanger 133 and the coolant flow cools the oil, then the coolant flow flows through the heating unit 111 and absorbs energy from the cooling unit 112 and reaches a higher temperature level before the coolant flow is conducted via the second and the third valves 162, 163 to the radiator 170, where heat is emitted to the surroundings.

Thereafter, the coolant flow flows via the first valve to the second coolant pump 152 and is conducted further to the cooling unit 112, where thermal energy is removed from the coolant flow, as a result of which the temperature of the coolant flow is lowered before the coolant flow flows to the first electronics units 120 with possible energy absorption, and further via the second and the third valves 162, 163 to the passenger compartment heat exchanger 140. From the passenger compartment, thermal energy is absorbed from the interior air and, as a result, the passenger compartment is cooled before the coolant flow is conducted to the battery 180 in order to absorb thermal energy there as well. The heat losses of all components are dissipated to the surroundings.

It is shown to be advantageous here that a thermal bypass is achieved here by the heat pump 110, which thermal bypass results in a considerable increase in the cooling capacity, in that the highest coolant flow temperature is reached in the inlet of the radiator 170 and, at the same time, the lowest coolant flow temperature in one single coolant flow circuit prevails in the inlet of the units to be cooled. In addition, air-conditioning of the vehicle is also possible.

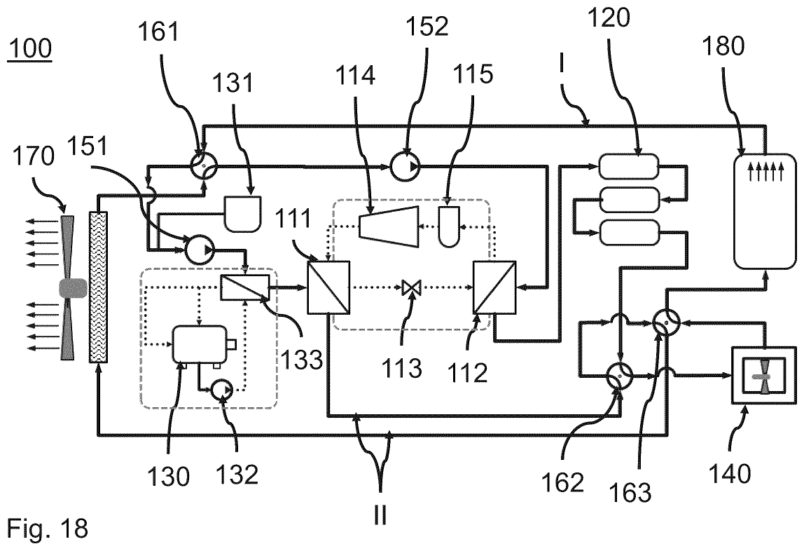

FIG. 18 shows, in comparison to FIGS. 16 and 17, the heat pump 110 and the motor heat exchanger 133 in the inactive state. The heat losses of the battery 180 are dissipated to the surroundings.

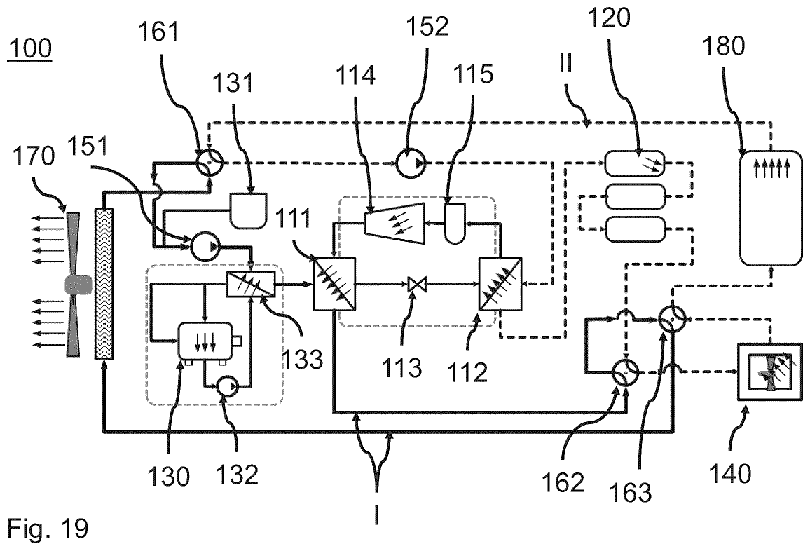

FIG. 19 shows the first valve 161 in the first switching state a), the second valve 162 in the first switching state c), and the third valve in the first switching state e), such that, according to FIG. 19, the dual-circuit configuration is present. The heat pump 110 and the motor heat exchanger 133 are in the active state. The LT conducting path conducts the coolant flow to the first system section 1SA to cool the first electronics units 120 and, thereafter, by the second valve 162, to the second system section 2SA to cool the passenger compartment heat exchanger 140. By the third valve 163, the coolant flow is conducted further to the third system section 3SA to cool the battery 180 and is conducted by the first valve 161 back to the cooling unit 112. The HT conducting path is conducted by the first and the second valves 162, 163 to the fourth system section 4SA to heat the radiator and via the first valve 161 to the fifth system section to cool the motor 130 or the motor heat exchanger 133 and then to the heating unit 111. The heat losses of the motor 130 and of the first electronics units 120, and thermal energy from the passenger compartment, as well as the electrical power of the heat pump 110 are transmitted into the HT conducting path and dissipated to the surroundings by the radiator 170.

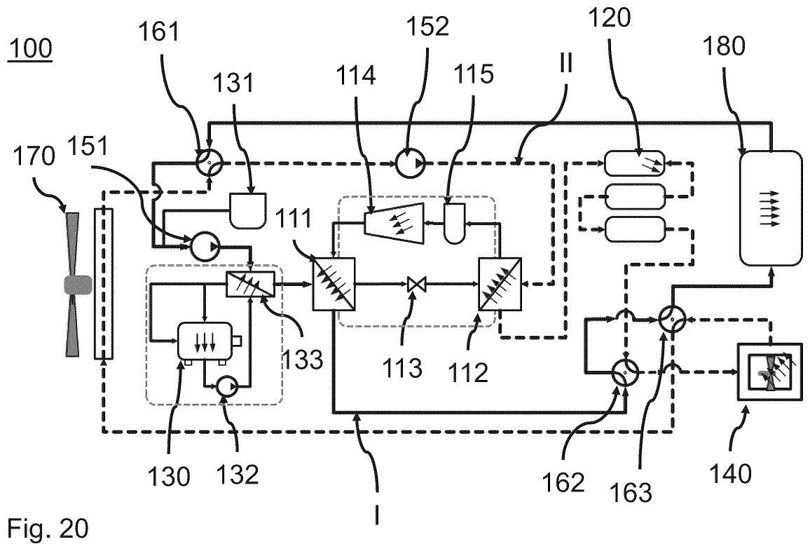

FIG. 20 shows the first valve 161 in the second switching state b), the second valve 162 in the first switching state c), and the third valve 163 in the second switching state f), such that the dual-circuit configuration is present. All units except for the radiator 170 are in the active state. The LT conducting path conducts the coolant flow to the first system section 1SA to cool the first electronics units 120 and via the second valve 162 to the second system section 2SA to cool the passenger compartment. By the third valve 163, the coolant flow is conducted to the fourth system section 4SA and via the first valve 161 to the cooling unit 111. The HT conducting path is conducted by the first and the second valves 162, 163 to the third system section 3SA to heat the battery 180 and via the first valve 161 to the fifth system section 5SA to cool the motor 130. Thereafter, the coolant flow is conducted to the heating unit 111. The heat losses of the motor 130 and of the first electronics units 120, as well as the electrical power of the heat pump 110 are transmitted into the HT conducting path.

Alternatively, the LT conducting path and the heat pump 110 can be in the inactive state. In this case, although the LT conducting path can have a coolant flow therethrough, the LT conducting path does not participate in the thermal conversion. The coolant pump 151 along the HT conducting path pumps the coolant flow to the motor heat exchanger 133 and the coolant flow absorbs heat losses from the motor 130. The heat losses of a transmission of the motor 130 and/or of the vehicle can also be absorbed. Thereafter, the coolant flow flows via the inactive heating unit 111 of the heat pump 110 and flows further through the second and the third valves 162, 163 to the battery 180 and emits the thermal energy before the coolant flow is supplied via the first valve 161 back to the first coolant pump 151 and thus the circuit is closed.

Alternatively, the radiator 170 can be in the active state and release thermal energy to the ambient air or absorb thermal energy from the ambient air. The heat losses of the motor 130 and of the first electronics units 120, and the thermal energy obtained from the ambient air, as well as the electrical power of the heat pump 110 are transmitted into the HT conducting path.

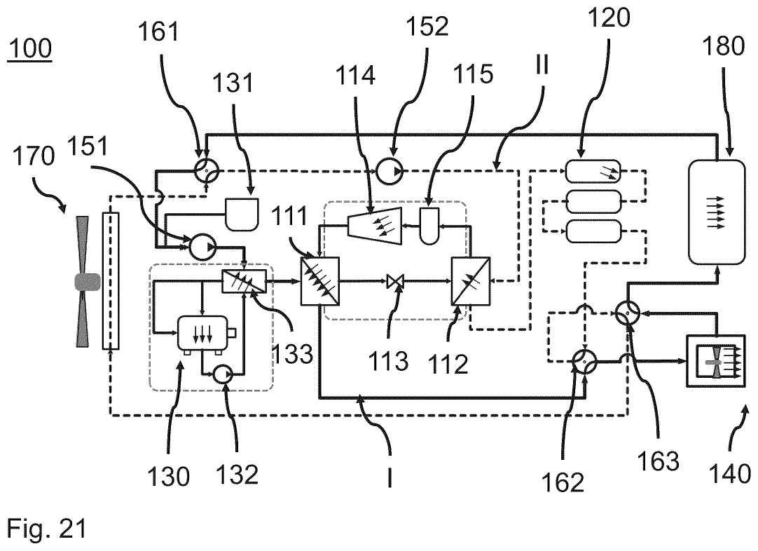

FIG. 21 shows the first valve 161 in the second state b), the second valve 162 in the second state d), and the third valve 163 in the first state e), such that the dual-circuit configuration is present. The LT conducting path conducts the coolant flow to the first system section 1SA to cool the first electronics units 120 and via the second and the third valves 162, 163 to the fourth system section 4SA before the coolant flow is conducted to the cooling unit 112. The HT conducting path conducts the coolant flow via the second valve 162 to the second system section 2SA to heat the passenger compartment and via the third valve 163 to the third system section 3SA to heat the battery 180. Thereafter, the coolant flow is conducted via the first valve 161 to the fifth system section 5SA to cool the motor 130 and then to the heating unit 111. Only the heat losses of the first electronics units 120 and the electrical power of the heat pump 110 are transmitted into the HT conducting path.

Alternatively, only the HT conducting path is active and the LT conducting path is inactive. The coolant flow of the LT conducting path can be circulated, but heat transport does not take place. Only the heat losses of the first electronics units 120 and the power losses of the heat pump 110 are transmitted into the HT conducting path for heating.

Alternatively, the radiator 170 can be in the active state and thermal energy can be absorbed from the ambient air.

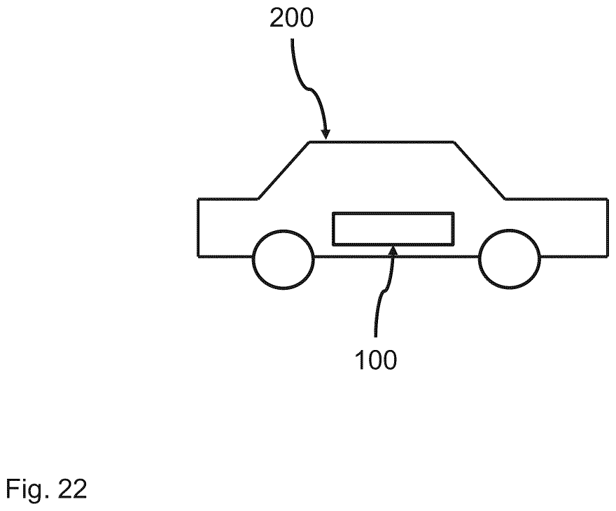

FIG. 22 shows a schematic view of a vehicle 200 including a thermal energy system 100 according to one of the preceding exemplary embodiments. The vehicle 200 can be designed to control the thermal energy system 100. In particular, the vehicle 200 can be designed to transmit control commands to one or more unit(s) of the thermal energy system 100 for the open-loop control of the thermal energy system 100. The vehicle 200 can be an electric and/or electronic vehicle having an electronic motor (electric motor).

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 thermal energy system
110 heat pump
111 heating unit
112 cooling unit
113 expansion valve
114 compressor
115 reservoir
HT HT conducting path
NT NT conducting path
120 first electronics units
121 second electronics units
123 third electronics units
124 expansion reservoir
125 choke
130 electric motor
131 expansion reservoir
132 oil pump
133 oil-water heat exchanger
1SA first system section
2SA second system section
3SA third system section
4SA fourth system section
5SA fifth system section
140 passenger compartment heat exchanger
141 first heat exchanger
142 second heat exchanger
151 first coolant pump
152 second coolant pump
161 first valve
162 second valve
163 third valve
164 bypass valve
170 radiator
180 battery
I first conducting path
II second conducting path
HTA high-temperature section
NTA low-temperature section
200 vehicle

1-18. (canceled)

19. A thermal energy system (100) for controlling temperatures of a vehicle, comprising:
a heat pump (110) with a cooling unit (112) for cooling coolant flow and a heating unit (111) for heating coolant flow, the heat pump configured such that thermal energy from coolant flow to the cooling unit (112) is suppliable to coolant flow to the heating unit (111);
a plurality of system sections (1SA-5SA) configured to heat and/or cool a respective vehicle section of the vehicle, a first system section (1SA) of the plurality of system sections (1SA-5SA) configured to cool a first vehicle section of the vehicle sections that includes at least one first electronics unit (120), a fifth system section (5SA) of the plurality of system sections (1SA-5SA) configured to cool a fifth vehicle section of the vehicle sections that includes a motor (130); and
a low-temperature conducting path beginning downstream of the cooling unit (112) and a high-temperature conducting path beginning downstream of the heating unit (111), at least one of the high-temperature and low-temperature conducting paths is configured to conduct coolant flow to at least one of the plurality of system sections (1SA-5SA),
wherein, downstream of the cooling unit (112), the low-temperature conducting path is configured to conduct coolant flow to the first system section (1SA),
wherein the low-temperature conducting path is configured such that, when conducting coolant flow to the fifth system section (5SA) downstream of the first system section (1SA), the low-temperature conducting path conducts coolant flow to at least one further system section (2SA, 3SA, 4SA) that is configured to cool and/or heat another vehicle section that includes a passenger compartment, a battery, or a radiator, and
wherein a first one (I) of the high-temperature and low-temperature conducting paths is configured to conduct coolant flow to the heating unit (111), and a second one (II) of the high-temperature and low-temperature conducting paths is configured to conduct coolant flow to the cooling unit (112).

20. The system (100) of claim 19, wherein one or more of:
a second system section (2SA) of the plurality of system sections (1SA-5SA) is configured to heat and cool a second vehicle section of the vehicle sections that includes a passenger compartment heat exchanger (140) of the passenger compartment of the vehicle;
a third system section (3SA) of the plurality of system sections (1SA-5SA) is configured to heat and/or cool a third vehicle section of the vehicle sections that includes the battery (170); and
a fourth system section (4SA) of the plurality of system sections (1SA-5SA) is configured to heat and/or cool a fourth vehicle section of the vehicle sections that includes the radiator (170).

21. The system (100) of claim 20, wherein one or more of:
the fifth system section (5SA) is configured to cool the fifth vehicle section of the vehicle sections to cool at least one second electronics unit (123) and to cool the motor (130) that is downstream of the second electronics unit (123);
the first system section (1SA) is also be configured to cool the first vehicle section such that the first system section (1SA) conducts coolant flow downstream of the first electronics unit (120) to the motor (130) and/or parallel to the first electronics unit (120); and
the third system section (3SA) is also be configured to heat and/or cool the third vehicle section such that the third system section (3SA) conducts coolant flow in series to a third electronics unit (121), the motor (130), and the battery (180).

22. The system (100) of claim 19, wherein one or both of:
wherein the low-temperature conducting path is a first conducting path (I) and the high-temperature conducting path is a second conducting path (II), the low-temperature conducting path is configured to conduct coolant flow in series to the first, the second, the third, and the fifth sections (1SA, 2SA, 3SA, 5SA), and the high-temperature conducting path is configured to conduct the coolant flow in series to the second and the fourth system sections (2SA, 4SA); and
the high-temperature conducting path is the first conducting path (I) and the low-temperature conducting path is the second conducting path (II), the high-temperature conducting path is configured to conduct coolant flow in series to the second, the fourth, and the fifth sections (2SA, 4SA, 5SA), and the low-temperature conducting path is configured to conduct coolant flow in series to the first, the second, and the third system sections (1SA, 2SA, 3SA).

23. The system (100) of claim 19, further comprising a first valve (161) and a second valve (162), each of the first and second valves (161, 162) adjustable to at least first and second switching states a), b) and c), d), each of the first and second valves (161, 162) comprising two valve inlets and two valve outlets for connecting to the high-temperature and low-temperature conducting paths,
wherein the high-temperature and low-temperature conducting paths are configured to conduct coolant flows. based on the switching states of the first and the second valves, to at least one of the plurality of system sections (1SA-5SA).

24. The system (100) of claim 23, wherein:
the first valve (161) is configured to conduct coolant flow, based on the first switching state a) of the first valve (161), from the fourth system section (4SA) to the fifth system section (5SA) or the heating unit (111), and to conduct coolant flow from the third system section (3SA) to the cooling unit (112); and
the first valve (161) is configured to conduct coolant flow, based on the second switching state b) of the first valve (161), from the third system section (3SA) to the fifth system section (5SA) or the heating unit (111), and to conduct coolant flow from the fourth system section (4SA) to the cooling unit (112).

25. The system (100) of claim 24, wherein:
the second system section (2SA) comprises a heating section and a cooling section;
the heating section is configured to heat a first heat exchanger (141) of a passenger compartment heat exchanger (140), and the cooling section is configured to cool a second heat exchanger (142) of a passenger compartment heat exchanger (140); and
the cooling section is arranged downstream of the first system section (1SA) and upstream of the third or the fourth system section (3SA, 4SA), and the heating section is arranged downstream of the heating unit (111) and upstream of the fourth or the third system section (4SA, 3SA).

26. The system (100) of claim 25, wherein:
the second valve (162) is configured to conduct coolant flow, based on the first switching state c) of the first valve (161), from the cooling section to the third system section (3SA), and to conduct coolant from the heating section to the fourth system section (4SA); and
the second valve (162) is configured to conduct coolant flow, based on the second switching state d) of the second valve (162), from the cooling section to the fourth system section (4SA), and to conduct coolant from the heating section to the third system section (3SA).

27. The system (100) of claim 23, further comprising a third valve (163) adjustable to at least first and second switching states e), f), the third valve (163) comprising two valve inlets and two valve outlets for connecting to the high-temperature and low-temperature conducting paths,
wherein the high-temperature and low-temperature conducting paths are configured to conduct coolant flows, based on the switching states of the first, second, and third valves (161, 162, 163), to at least one of the plurality of system sections (1SA-5SA).

28. The system (100) of claim 27, wherein the second and the third valves (162, 163) are configured to one or more of:
based on the first switching states c), e) of the second and third valves (162, 163), to conduct coolant flow from the first system section (1SA) to the second system section (2SA), to conduct coolant flow from the second system section (2SA) to the third system section (3SA), and to conduct coolant flow from the heating unit (111) to the fourth system section (4SA);
based on the first switching state c) of the second valve (162) and the second switching state f) of the third valve (163), to conduct coolant flow from the first system section (1SA) to the second system section (2SA), to conduct coolant flow from the second system section (2SA) to the fourth system section (4SA), and to conduct coolant flow from the heating unit (111) to the third system section (3SA);
based on the second switching state d) of the second valve (162) and the first switching state e) of the third valve (163), to conduct coolant flow from the first system section (1SA) to the fourth system section (4SA), to conduct coolant flow from the heating unit (111) to the second system section (2SA), and to conduct coolant flow from the second system section (2SA) to the third system section (3SA); and
based on the second switching states d) and f) of the second and third valves (162, 163), to conduct coolant flow from the first system section (1SA) to the third system section (3SA), to conduct coolant flow from the heating unit (111) to the second system section (2SA), and to conduct coolant flow from the second system section (2SA) to the fourth system section (4SA).

29. The system (100) of claim 29, wherein, based on the switching states of at least one of the first, second, and third valves (161, 162, 163), the thermal energy system (100) is configured to heat and/or cool one or more of the second, the third, the fourth, and the fifth system section(s) (2SA, 3SA, 4SA, 5SA) by the high-temperature and low-temperature conducting paths.

30. The system (100) of claim 19, further comprising one or both of a first coolant pump (151) and a second coolant pump (151),
wherein the first coolant pump (151) is arranged along a first conducting path (I) upstream of the heating unit (111) or upstream of the fifth system section (5SA) and configured to pump coolant flow to the heating unit (111),
wherein the second coolant pump (152) is arranged along a second conducting path (II) upstream of the cooling unit (112) and configured to pump coolant flow to the cooling unit (112).

31. The system (100) of claim 30, wherein:
the first and/or the second coolant pump (151, 152) is adjustable to an active state and an inactive state;
the first and/or the second coolant pump(s) (151, 152) in the active state is configured to pump coolant flow; and
the first and/or the second coolant pump(s) (151, 152) in the inactive state is configured to conduct coolant flow without pumping.

32. The system (100) of claim 19, wherein coolant flow of the high-temperature conducting path has a higher temperature when exiting the heating unit (111) than that of coolant flow of the low-temperature conducting path when exiting the cooling unit (112).

33. The system (100) of claim 19, wherein:
the heat pump (110) is adjustable to an active state and an inactive state;
the heating pump (110) is configured, in the active state, to supply thermal energy from coolant flow supplied to the cooling unit (112) and to coolant flow to the heating unit (111); and
the heat pump (110) is configured, in the inactive state, to limit exchange of thermal energy between the cooling unit (112) and the heating unit (111).

34. The system (100) of claim 19, wherein the fifth system section (5SA) is configured to cool an oil-water heat exchanger for cooling the motor (133).

35. The system (100) of claim 19, wherein:
one or both of the high-temperature conducting path and the low-temperature conducting path is adjustable to an active state and an inactive state;
thermal energy is transported by coolant flow in the active state of the one or both of the high-temperature conducting path and the low-temperature conducting path, and
the one or both of the high-temperature conducting path and the low-temperature conducting path is configured to limit transport of thermal energy in the inactive state of the one or both of the high-temperature conducting path and the low-temperature conducting path.

36. A vehicle (200) comprising the thermal energy system (100) of claim 18.
